(19) United States
(12) Patent Application Publication
(10) Pub. No.: US 2008/0265635 A1
(43) Pub. Date: Oct. 30, 2008

(54) Bicycle Saddle

(76) Inventors: Lutz Scheffer, Pforheim (DE); Andreas Heimerdinger, Pforheim (DE)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/661,640

(22) PCT Filed: Sep. 1, 2005
(86) PCT No.: PCT/EP05/54313

§ 371 Date: Jan. 18, 2008

(30) Foreign Application Priority Data
Sep. 1, 2004 (DE) 2004 013 746.1

(51) Int. Cl. B62J 1/00

(52) U.S. Cl. 297/201

(57) ABSTRACT

The comfort of use may be improved and pressure in the genital area of a bicycle rider may be avoided, whereby a bicycle saddle comprises a seat piece for the buttocks of a bicycle rider and a front section, connected to the seat piece. The front section comprises an end region, facing the seat piece which is height-adjustable.

### BACKGROUND

1. Field of the Disclosure

The disclosure relates to a bicycle saddle, particularly a men's bicycle saddle, as it is used for bicycles, particularly mountain bikes, racing bikes and the like.

2. Discussion of the Background Art

Generally, bicycle saddles are provided with a seat piece for the bottom of a cyclist in the rear portion of the bicycle saddle. In the traveling direction, the seat piece merges into a narrow and elongate front section. Such a bicycle saddle has the disadvantage that it exerts a pressure on the genital area of the cyclist during cycling. The pressure onto the genital area is disagreeable for the cyclist and reduces the cycling comfort. Further, the cyclist runs the risk of permanent medical problems particularly when cycling over long periods of time.

From DE 199 32 031 A1, it is known to hinge the front section of the bicycle saddle to the seat piece so that the front section of the bicycle saddle can be folded down to avoid pressure in the genital area. This bicycle saddle has the disadvantage that an actual relief in the genital area is not achieved when the front section is folded down. Particularly, it is not possible to individually set the bicycle saddle for a cyclist.

It is the object of the disclosure to provide a bicycle saddle where the pressure in the genital area of the cyclist is reduced.

### SUMMARY OF THE DISCLOSURE

The bicycle saddle according to the disclosure, which particularly is a men's bicycle saddle, comprises a seat piece for the bottom of a cyclist and a front section following the seat piece. The front section comprises an end region facing the seat piece, the end region being particularly located below the genital area of the cyclist. According to the disclosure, at least the end region of the front section is height-adjustable relative to the seat piece, i.e., the end region as a whole is adapted to be moved with a movement component in vertical direction.

The height adjustment of the end region of the front section of the bicycle saddle is preferably achieved by the fact that the front section comprises a pivot axis spaced from the seat piece. “Pivot axis” particularly means an imaginary line that serves as a reference line for a pivotal movement of the front section. This virtual pivot axis may be realized as a concrete object but not necessarily so. By the spaced arrangement of the pivot axis, it is achieved that particularly the front portion or saddle tip of the front section is fixed relative to the seat piece and the end region is adapted to be pivoted upwards or downwards. Thereby, the pressure in the genital area can be reduced by the height adjustment of the end region.

Preferably, the end region is spring-loaded so that sudden shocks can be buffered or dampened. The height level of the end region is automatically regulated by the resilience. When the cyclist leans forward during cycling, for example, the end region may hence give way so that a disagreeable stress of the genital area of the cyclist is avoided. As soon as the cyclist leans back again, the end region may move back again to restore the original bicycle saddle shape. The hardness and the range of spring may be individually adapted to the cyclist, particularly to his anatomy and his weight, whereby the cycling comfort is improved. Further, the automatic level regulation achieved by the spring-loaded end region may be designed such that a certain residual pressure of the end region onto the genital area of the cyclist is maintained. Thereby, it is avoided that the end region is folded away completely, and the cyclist also experiences a certain support by the end region which leads to a feeling of security when cycling and thereby further improves the cycling comfort.

Additionally or alternatively, the height adjustment of the end region may be achieved by connecting the front section to the seat piece via an adjusting means being able to move the seat piece relative to the front section in substantially vertical direction. Thus, the seat piece is height-adjustable relative to the front section with the horizontal orientation being substantially the same.

Preferably, the front section and the seat piece are spaced from each other so that the bicycle saddle is divided in transverse direction. The distance between the front section and the seat piece can be closed, if necessary, by a flexible material such as a foil and/or an elastic material, e.g., a foamed material, so that, on the one hand, the relative movement of the front section and the seat piece is permitted and, on the other hand, the cyclist is protected from splash water.

The bicycle saddle according to the disclosure can be individually adapted to a cyclist. Particularly by combining the end region of the front section, which is adapted to be lowered by a pivotal movement, and the relative height adjustment of the seat piece relative to the front section in vertical direction, the saddle tip of the front section and the end region of the front section can be set almost arbitrarily in height so that the bicycle saddle according to the disclosure can be adapted individually to the comfort requirements of the cyclist. To this end, the front section comprises, for example, a stop in the end region in particular, the distance of which to the front section can be adjusted so that the front section can be pivoted into any position. Further, the adjusting means may comprise a locking means to be able to displace the seat piece relative to the front section over defined distances between locking positions. Further, the adjusting means may comprise a screw connection or the like to achieve a continuous height adjustment. Thereby, it is possible to achieve major height adjustments by, e.g., the locking means and to achieve a fine adjustment by means of the screw connection.

Preferably, the front section is configured so as to be resilient in vertical direction, particularly in the end region. For example, by using a suitable padding and/or distance knit fabric. Particularly, the front section is spring-loaded by means of a spring element which is a leaf spring in particular. Thereby, sudden shocks can be buffered and dampened, if necessary. Preferably, the distance of the front section to the spring element is adjustable by means of a distance adjusting element. The distance adjusting element, for example, may be the stop which is adjustable relative to the front section. Particularly, the spring hardness of the spring element can be adjusted by means of a hardness adjusting element. By means of the hardness adjusting element, for example, the bias of the spring element is varied. Further, the spring length of the spring element can be adjusted by means of a length adjusting element. Thus, the spring characteristic of the spring element can be adapted individually to the cyclist.

Preferably, the spring element comprises at least one leaf spring with a wire-shaped configuration. The spring element may consist of, e.g., spring steel or stainless steel. Particularly, the spring element is connected to both the front section and the seat piece so that the stability of the bicycle saddle is improved.

Particularly, the front section and the seat piece can be connected with each other via at least one supporting web. Particularly, the supporting web comprises a fastening means for being fastened to a saddle tube so that an independent connection of the front section and the seat piece to the saddle tube is avoided and the mounting efforts are reduced. Preferably, the supporting web is connected with the pivot axis and/or with the adjusting means so that the height adjustment of the end region of the front section can be realized particularly easily. The supporting web, for example, is inserted into a pocket in the front region of the front section so that the front section can be pivoted particularly easily about the end of the supporting web inserted into the pocket, thus particularly forming the pivot axis.

The spring element and/or the supporting web comprise unidirectionally resined carbon fibers in particular so that the bicycle saddle according to the disclosure may have a configuration that is light-weighted and stable at the same time.

Hereinafter, the disclosure is explained in detail with reference to the accompanying drawings.

### BRIEF DESCRIPTION OF THE DRAWINGS

FIG. 1 shows a schematic perspective view of a bicycle saddle according to the disclosure,

FIG. 2 shows a schematic view of the bicycle saddle from below,

FIG. 3 shows a schematic sectional view of the bicycle saddle along the line III-III of FIG. 2,

FIG. 4 shows a schematic sectional view of the bicycle saddle in an alternative embodiment along the line III-III of FIG. 2,

FIG. 5 shows a schematic sectional view of the bicycle saddle along the line V-V of FIG. 2, and

FIG. 6 shows a schematic sectional view of the bicycle saddle in an alternative embodiment along the line V-V of FIG. 2.

### DETAILED DESCRIPTION OF THE PREFERRED EMBODIMENT

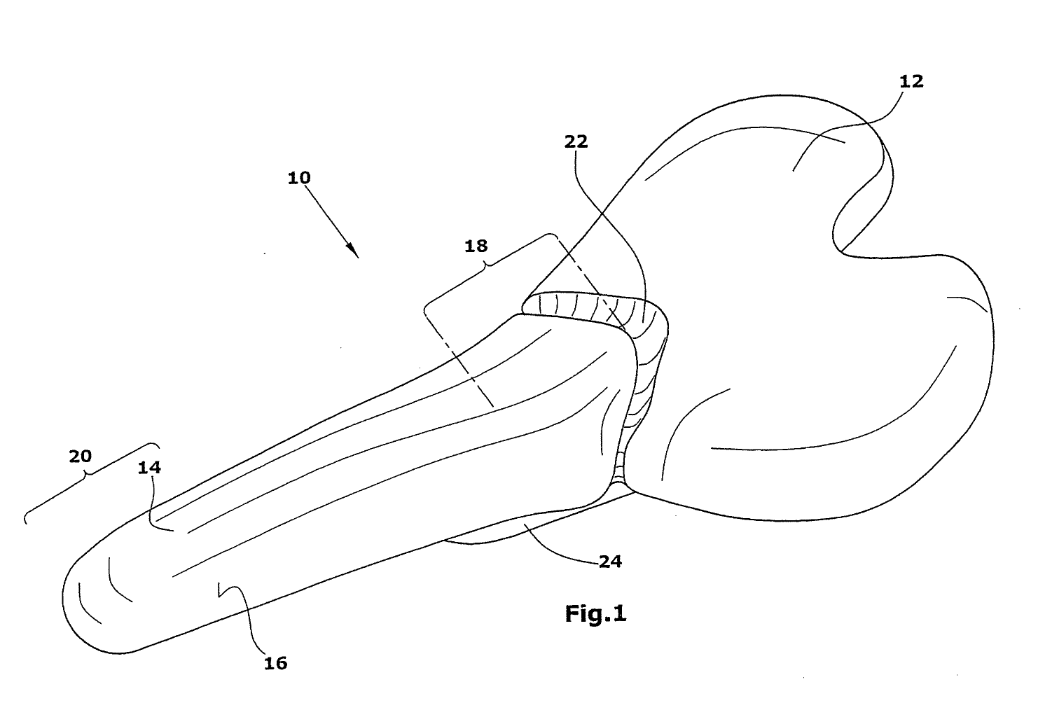

The bicycle saddle 10 according to the disclosure comprises a seat piece 12 and a front section 14 with lateral surfaces 16 (FIG. 1). Particularly, the seat piece 12 is shaped such that the bottom of the cyclist is substantially completely accommodated by the seat piece 12 during cycling. The front section comprises an end region 18 facing the seat piece and being, according to the invention, height-adjustable to reduce the pressure on the genital area of the cyclist. Further, the front section 14 comprises a front region 20 facing away from the seat piece 12 and forming the saddle tip. The seat piece 12 and the front section 14 are spaced from each other so that there is a gap 22 between the seat piece 12 and the front section 14, being adapted to be filled with a resilient, flexible or elastic material, if necessary.

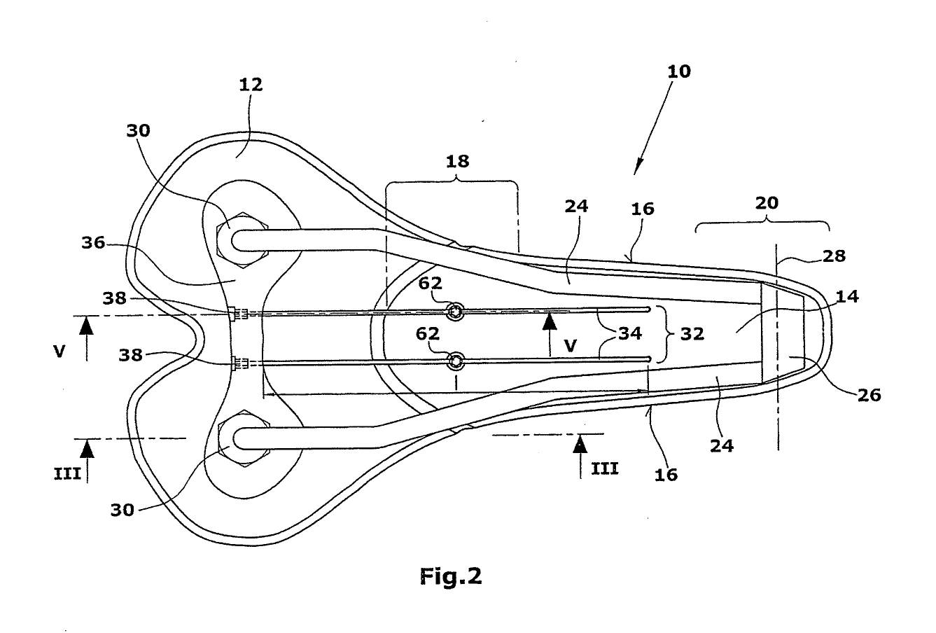

The seat piece 12 and the front section 14 are connected to each other via supporting webs 24 (FIG. 2). The supporting webs 24 are arranged in a pocket 26 of the front section 14. Particularly, the pocket 26 is arranged in the front region 20 of the front section 14. Preferably, the supporting webs 24 have a distinct play in the pocket 26 so that a relative movement of the front section 14 relative to the supporting webs 24 is possible. It is particularly possible that the front section 14 is adapted to be pivoted about a pivot axis 28 extending through the pocket 26 without a pivot shaft or hinge being necessary therefore. Thereby, the end region 18 of the front section 14 is height-adjustable relative to the seat piece 12. Each of the supporting webs 24 is further connected with an adjusting means 30. By means of the adjusting means 30, the seat piece 12 can be adjusted in vertical direction relative to the front section 14. Further, the seat piece 12 can be moved out of the horizontal plane to set the stresses on the buttock halves differently. It is also possible, however, to connect both supporting webs 24 by a common transverse web or a common transverse plate and to use precisely one single adjusting means 30.

Further, the bicycle saddle 10 comprises a spring element 32 comprising two wire-shaped leaf springs 34 in the illustrated embodiment. At their one end, the leaf springs 34 are connected with the front section 14 and at their other end, with a connecting body 36 forming part of the seat piece 12. The leaf springs 34 have a screw connection 38 completely countersunk in the connecting body 36. In the illustrated embodiment, the configuration of the screw connection 38 is similar to that of a screw connection of a bicycle spoke in order to fasten the leaf springs 34 while requiring little space.

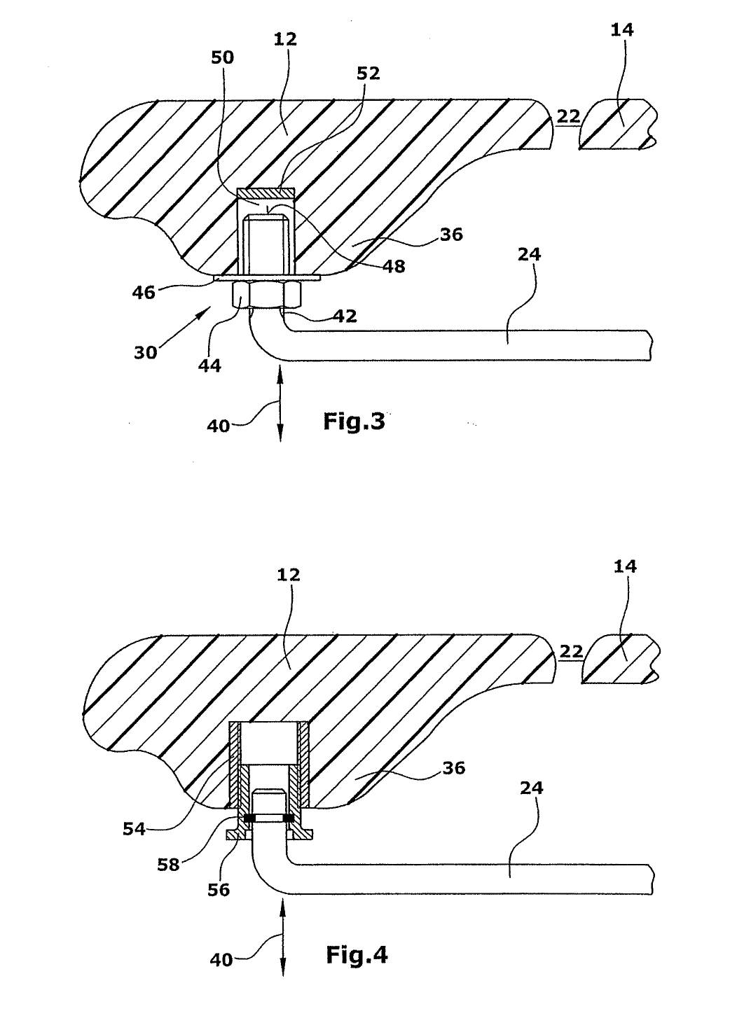

Further, the adjusting means 30 is provided in the connecting body 36 (FIG. 3). In order to adjust the height of the seat piece 12 in the direction of the arrow 40, i.e., in vertical direction, the supporting web 24 has a thread 42 in the illustrated embodiment onto which a nut 44 is screwed. Depending on the position of the nut 44, the height of the seat piece 12 is adjusted via a distance plate 46 which, if necessary, is fixed to the seat piece 12. To this end, an end 48 of the supporting web 24 projects into an opening 50 of the seat piece 12 or the connecting body 36. At the upper end of the opening 50, a stop 52 may be provided that is particularly cast into the seat piece 12.

Alternatively, the adjusting means 30 may also be configured such that in the seat piece 12, a sleeve 54 is arranged into which an adjusting sleeve 56 can be screwed (FIG. 4). To this end, the supporting web 24 is held permanently in the adjusting sleeve 56 by means of a snap ring 58. Thereby, a firm connection of the supporting webs 24 with the vertically adjustable seat piece 12 is achieved.

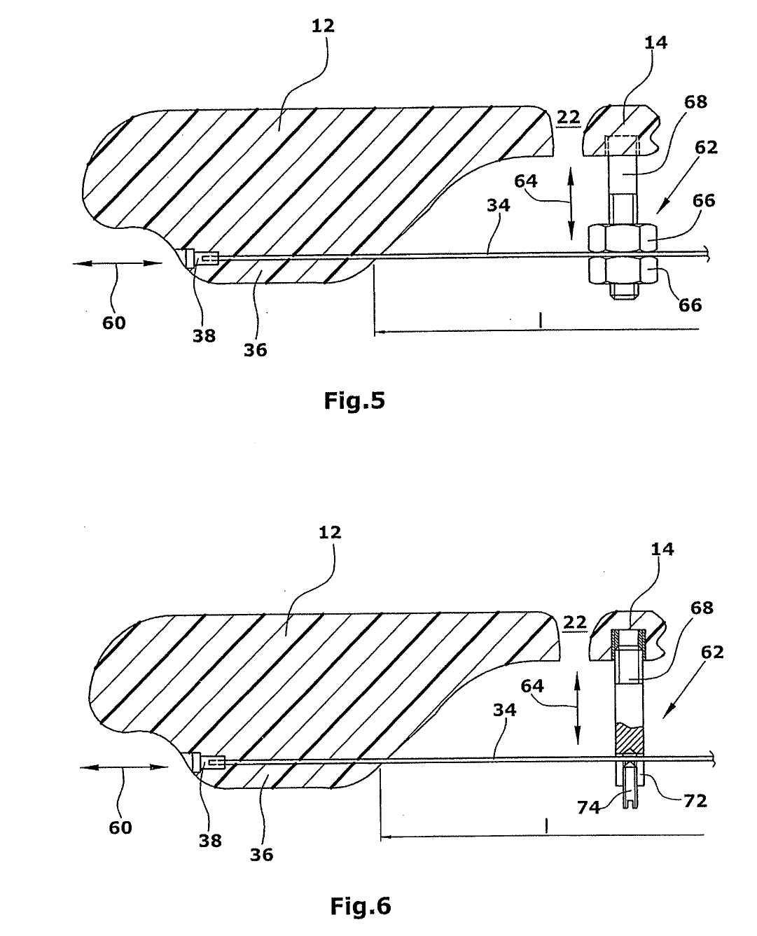

By means of the screw connection 38 of the leaf spring 34, the spring length l of the spring 32 or the leaf spring 34 can be adjusted by moving the leaf spring 34 in the direction of an arrow 60, i.e., in horizontal direction (FIG. 5). Thus, the screw connection 38 also acts as a length adjusting element. Thereby, it is possible, for example, to replace the front section 14 by another front section 14 and to compensate for possible distance variations in longitudinal direction of the bicycle saddle 10. Further, it is possible to set the bias of the leaf springs 34 by means of the screw connection 38 so that the screw connection 38 may also act as a hardness adjusting element.

The distance of the front section 14 to the spring element 32 can be adjusted by means of a distance adjusting element 62 by means of which it is possible to move the front section 14 in the direction of an arrow 64 in vertical direction. To this end, the leaf spring 34, for example, is guided by means of nuts 66 and cramped, if necessary. The nuts 66 may be screwed onto a bolt 68 which, if necessary, is cast into the front section 14. Further, the bolt 68 and the nuts 66 may be replaced by a single screw that preferably comprises a slot into which not only a screwdriver but also the leaf spring 34 fits. Thereby, it is possible to guide the leaf spring 34 in the slot of a slotted screw. In this case, the screw head serves as guide and stop simultaneously.

Alternatively, the bolt 68 may be screwed into the front section 14 by means of a sleeve 70 (FIG. 6). To this end, the bolt 68 preferably comprises a slot 72 into which the leaf spring 34 may be inserted. At the same time, the slot 72 serves to receive a screwdriver for screwing the bolt 68 into the front section 14. Preferably, the bolt 68 is provided with a tapped bore in the region of the slot 72 so that, e.g., a stud screw 74 can be screwed into it to fix the leaf spring 34. If the leaf spring 34 shall only be guided and not be fixed, the slot 72 is sufficient so that the tapped bore and the stud screw 74 are not required.

It is thus possible to realize the connection of the front section 14 with the spring element 32 in various manners. On the one hand, it is possible that the front section 14 is supported on the spring element 32 via a stop, if necessary. In another embodiment, the stop may be configured so as to be adjustable in order to realize the distance adjusting element 62. The stop or distance adjusting element 62 or the front section 14 may comprise a guide for the spring element 32 in which the spring element 32 is loosely guided. Further, it is possible to fix the distance adjusting element 62 or another non-adjustable stop by means of the spring element 32 so that a reliable bond is achieved which results in a resilient end region 18 due to the spring action of the spring element 32 in order to thus reduce a pressure onto the genital area of the cyclist.

1. A bicycle saddle comprising:
a seat pieced for the bottom of a cyclist, and
the seat pieces being followed by a front section, comprising an end region facing the seat piece,
wherein at least the end region of the front section is height-adjustable relative to the seat piece.

2. The bicycle saddle according to claim 1, wherein the front section comprises a pivot axis spaced from the seat piece, for adjusting the height of the end region.

3. The bicycle saddle according to claim 1, wherein the front section is connected to the seat piece via an adjusting means, the seat piece being height-adjustable relative to the front section by means of the adjusting means, the horizontal orientation being substantially the same.

4. The bicycle saddle according to claim 3, wherein the adjusting means comprises a locking means.

5. The bicycle saddle according to claim 3, wherein the adjusting means comprises an adjusting element for a continuous height adjustment.

6. The bicycle saddle according to claim 1, wherein the front section and the seat piece are spaced from each other to divide the bicycle saddle in transverse direction.

7. The bicycle saddle according to claim 1, wherein the front section has a resilient configuration in vertical direction.

8. The bicycle saddle according to claim 1, wherein the front section is spring-loaded by means of a spring element.

9. The bicycle saddle according to claim 8, wherein the distance of the front section to the spring element is adapted to be adjusted by a distance adjusting element.

10. The bicycle saddle according to claim 8, wherein the spring hardness of the spring element is adapted to be adjusted by a hardness adjusting element.

11. The bicycle saddle according to claim 8, wherein the spring element comprises at least one leaf spring with a wire-shaped configuration.

12. The bicycle saddle according to claim 8, wherein the spring length of the spring element is length-adjustable by means of a length adjusting element that is particularly configured as a screw connection which is preferably adapted to be countersunk.

13. The bicycle saddle according to claim 8, wherein the spring element comprises unidirectional resined carbon fibers.

14. The bicycle saddle according to claim 1, wherein the front section and the seat piece are connected via at least one supporting web that particularly comprises unidirectional resined carbon fibers.

15. The bicycle saddle according to claim 14, wherein the supporting web is connected with the pivot axis and/or with the adjusting means.

16. The bicycle saddle according to claim 14, wherein the supporting web is connected with a fastening means for being fastened to a saddle tube.
